(19) United States
(12) Patent Application Publication
(10) Pub. No.: US 2020/0103233 A1
(43) Pub. Date: Apr. 2, 2020

(54) DECENTRALIZED DISTRIBUTED MAP USING BLOCKCHAIN

(71) Applicant: GM Global Technology Operations LLC, Detroit, MI (US)

(72) Inventor: Donal B. McErlean, Ennis (IE)

(21) Appl. No.: 16/148,197

(22) Filed: Oct. 1, 2018

(51) Int. Cl. G01C 21/28

(52) U.S. Cl. CPC G01C 21/28; H04L 67/12

(57) ABSTRACT

A system for updating a distributed navigation map for a motor vehicle includes one or more sensors that evaluates and characterizes a surrounding around the motor vehicle and a discrepancy detector that identifies differences in the surrounding compared to a known navigation map based on information received from the one or more sensors. The differences are transmitted to a blockchain map network.

### INTRODUCTION

The present disclosure relates to navigation map for a motor vehicle. More specifically, the present disclosure relates to a decentralized distributed map using blockchain.

Currently, many motor vehicles utilize some type of navigation system that provides detailed maps to the driver of the motor vehicle or the automated driving system of an autonomous motor vehicle regarding the geographic location of the vehicle and directions to a desired destination. Current mapping systems, however, are difficult to keep dynamic without incurring large costs.

Thus, while current navigation mapping systems achieve their intended purpose, there is a need for a new and improved system and method for distributing navigation maps to motor vehicles.

### SUMMARY

According to several aspects, a system for updating a distributed navigation map for a motor vehicle includes one or more sensors that evaluates and characterizes a surrounding around the motor vehicle and a discrepancy detector that identifies differences in the surrounding compared to a known navigation map based on information received from the one or more sensors. The differences are transmitted to a blockchain map network.

In an additional aspect of the present disclosure, the motor vehicle transmits the differences to the blockchain map network through a telematics module.

In another aspect of the present disclosure, the identified differences includes GPS information.

In another aspect of the present disclosure, the differences are a blockchain candidate transaction.

In another aspect of the present disclosure, the blockchain candidate transaction is compared to a blockchain navigation map.

In another aspect of the present disclosure, the differences are valid, a validation transaction is transmitted to the blockchain map network.

In another aspect of the present disclosure, each of a plurality of motor vehicles transmit blockchain candidate transactions to the blockchain map network.

In another aspect of the present disclosure, each of a plurality of motor vehicles transmits a validation transaction to the blockchain map network if the differences identified for the respective motor vehicle are valid.

According to several aspects, a method of updating a distributed navigation map for a motor vehicle evaluating and characterizing a surrounding around the motor vehicle with one or more sensors, identifying with a discrepancy detector differences in the surrounding compared to a known navigation map based on information received from the one or more sensors, and transmitting the differences to a blockchain map network.

In another aspect of the present disclosure, the motor vehicle transmits the differences to the blockchain map network through a telematics module.

In another aspect of the present disclosure, the identified differences includes GPS information.

In another aspect of the present disclosure, the differences are a blockchain candidate transaction.

In another aspect of the present disclosure, the blockchain candidate transaction is compared to a blockchain navigation map.

In another aspect of the present disclosure, the differences are valid, a validation transaction is transmitted to the blockchain map network.

In another aspect of the present disclosure, each of a plurality of motor vehicles transmits blockchain candidate transactions to the blockchain map network.

In another aspect of the present disclosure, each of a plurality of motor vehicles transmits a validation transaction to the blockchain map network if the differences identified for the respective motor vehicle are valid.

According to several aspects, a method of updating a distributed navigation map for a motor vehicle includes evaluating and characterizing a surrounding around the motor vehicle with one or more sensors, identifying with a discrepancy detector differences in the surrounding compared to a known navigation map based on information received from the one or more sensors, and transmitting the differences to a blockchain map network through a telematics module, the identified differences including GPS information. The differences are a blockchain candidate transaction compared to a blockchain navigation map.

In another aspect of the present disclosure, if the differences are valid, a validation transaction is transmitted to the blockchain map network.

In another aspect of the present disclosure, each of a plurality of motor vehicles transmits blockchain candidate transactions to the blockchain map network.

In another aspect of the present disclosure, each of a plurality of motor vehicles transmits a validation transaction to the blockchain map network if the differences identified for the respective motor vehicle are valid.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a system for updating a distributed navigation map for a motor vehicle according to an exemplary embodiment; and

FIG. 2 is a sequence of steps for updating a blockchain according to an exemplary embodiment.

### DETAILED DESCRIPTION

The following description is merely exemplary in nature and is not intended to limit the present disclosure, application, or uses.

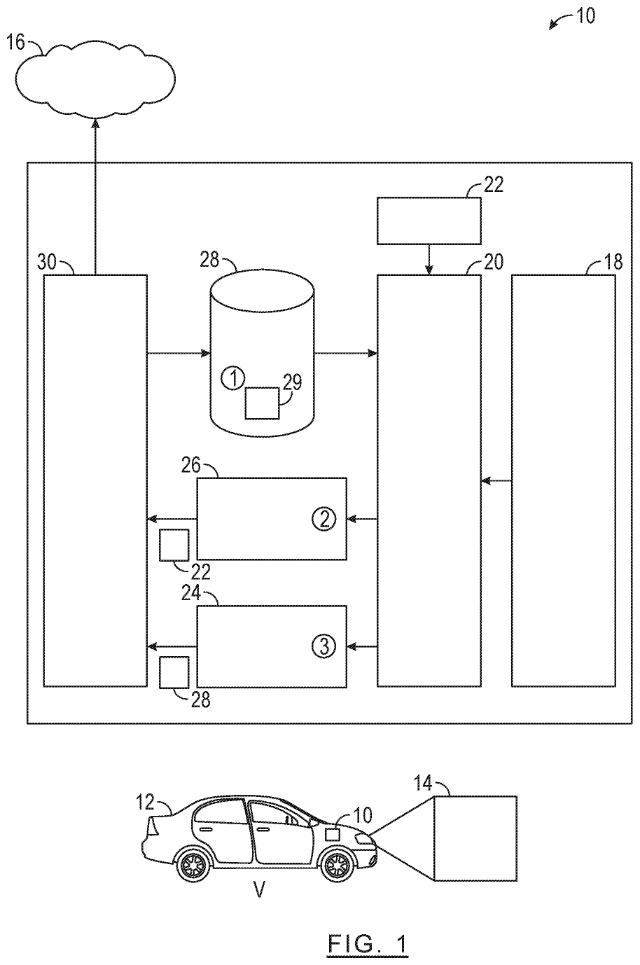

Referring to FIG. 1, there is shown a system 10 implemented in a motor vehicle 12 for updating a distributed navigation map to the motor vehicle 12 as well as other motor vehicles that communicate with a blockchain map network 16. More specifically, the system 10 continuously updates the distributed map in a decentralized manner to vehicles that communicate with each other in a distributed vehicle-to-vehicle (or peer-to-peer) network. The blockchain is a growing list of blocks that are linked utilizing cryptography. Each block includes cryptographic hash of the previous block, a timestamp, and transactions data.

In certain arrangements, the system 10 includes one or more sensors 18 that detect a road change 14. The road change 14 is, for example, a change in the lanes along a road, a traffic sign, speed limit changes, or any other changes in the road conditions as the motor vehicle 12 travels along the road. The one or more sensors 18 communicate with a processor, such as, for example, a perception and localization processor 20. In various arrangements, the processor 20 is implemented with an algorithm associated with the operation of the system 10. In particular arrangements, the algorithm is a software algorithm stored in a non-transitory computer readable mechanism associated with the processor 20.

The processor 20 also communicates with a blockchain map 28, that is, the processor 20 receives a distribute high definition map (1), which contains map transactions that may be utilized for navigation, and also candidate map transactions, such as Ac 29 transmitted to the process 20 by a telematics module 30 that receives data from the blockchain map 28. Accordingly, the processor 20 utilizes information from the one or more sensors 18 and GPS 22 to compare observed surroundings detected by the one or more sensors 14 with the blockchain map 28.

The system 10 includes a discrepancy detector 26 that communicates with the processor 20. If a discrepancy (2) is observed, the discrepancy detector 26 identifies a candidate transaction, BC, 22 that is transmitted to the telematics module 30 in the system 10, which, in turn, broadcasts the candidate transaction, Bc, 22 to the blockchain map network 16 along with the map data associated with the transaction.

The blockchain map network 16 contains vehicles and/or statically placed mining nodes in data centers. While, in certain arrangements, the motor vehicle 12 does not utilize the map data associated with the candidate map transaction, Ac, 29, as the motor vehicle is being driven, the processor 20 does compare the candidate map transaction, Ac, 29 map change with the observations from the one or more sensors 18 at the location of the transactions, should the motor vehicle 10 traverse the road associated with the transaction.

If the processor 20 validates the candidate map transaction, Ac, 29 as being a valid change, this information (3) is relayed to a candidate validator 24. The candidate validator 24, in turn, transmits a validation transaction, Av, 28 to the telematics module 20, which broadcast the validation transaction, Av, 28 to the blockchain map network 16.

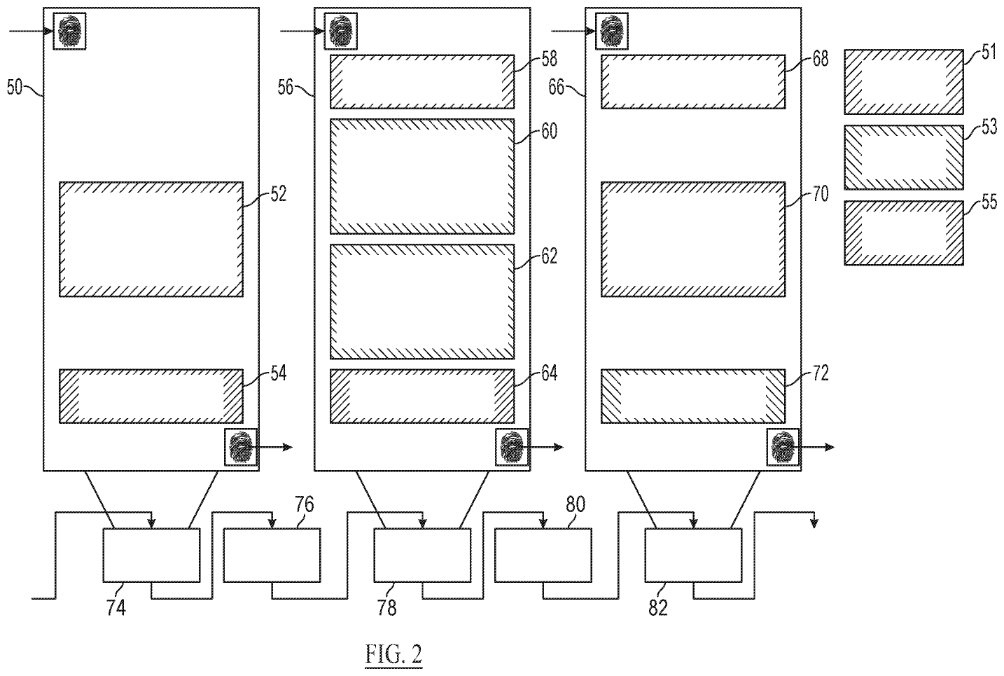

Referring now to FIG. 2, there is shown an example of a sequence of transaction steps 50, 56, 66 associated with the system 10. In each transaction step 50, 56, 66, a different type of transaction may occur, such as, a candidate transaction 51, a validation transaction 53, and an accepted transaction 55. Accordingly, in the transaction step 50, a candidate transaction 52 and an accepted transaction 54 occurs. This information is communicated to the blockchain map 74 to yield an updated blockchain map 76, which then receives information from the transaction step 56. Specifically, the transaction step 56, provides an accepted transaction 58 for a previous transaction, and two validated transactions 60 and 62 associated with the previous candidate transaction 52. An accepted transaction 64 is further identified in the transaction step 56. The blockchain map 76 receives information from the transaction step 56 in a blockchain map 78 to produce an updated blockchain map 80.

In the next transaction step 66, a new candidate transaction 68 occurs and the previous validation transactions 60 and 62 become an accepted transaction 70. The previous accepted transaction 54 becomes a validated transaction 72. The blockchain map 80 is then updated with the information from the transaction step 66 in a block chain map 82.

Candidate transactions with enough associated validation transactions following them may be promoted to be a validated transactions that are safe for navigational use, during block generation, as can be seen by the progression of the candidate transaction 52, the validation transactions 60 and 62, and the accepted transaction 70 in the blockchain show in FIG. 2.

In various arrangements, bad actors who generate erroneous candidate transactions are blacklisted if the blockchain shows a pattern of bad candidates, or require higher number of ‘validation transactions’ for their entries to become accepted map transactions. Similarly, bad actors who have history in the block chain of providing erroneous ‘validation transactions’ are also blacklisted or have less voting power assigned to their validation transactions.

The system 10 has one or more benefits including decentralizing the updating of navigation maps, democratizing map generation from vendors, reducing costs for map changes that are validated across many vehicles, and enabling rapid updates of navigation maps.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for updating a distributed navigation map for a motor vehicle, the system comprising:
one or more sensors that evaluates and characterizes a surrounding around the motor vehicle; and
a discrepancy detector that identifies differences in the surrounding compared to a known navigation map based on information received from the one or more sensors,
wherein the differences are transmitted to a blockchain map network.

2. The system of claim 1 wherein the motor vehicle transmits the differences to the blockchain map network through a telematics module.

3. The system of claim 2 wherein the identified differences includes GPS information.

4. The system of claim 2 wherein the differences are a blockchain candidate transaction.

5. The system of claim 4 wherein the blockchain candidate transaction is compared to a blockchain navigation map.

6. The system of claim 5 wherein if the differences are valid, a validation transaction is transmitted to the blockchain map network.

7. The system of claim 6 wherein each of a plurality of motor vehicles transmit blockchain candidate transactions to the blockchain map network.

8. The system of claim 6 wherein each of a plurality of motor vehicles transmits a validation transaction to the blockchain map network if the differences identified for the respective motor vehicle are valid.

9. A method of updating a distributed navigation map for a motor vehicle, the method comprising:
evaluating and characterizing a surrounding around the motor vehicle with one or more sensors;
identifying with a discrepancy detector differences in the surrounding compared to a known navigation map based on information received from the one or more sensors; and
transmitting the differences to a blockchain map network.

10. The method of claim 9 wherein the motor vehicle transmits the differences to the blockchain map network through a telematics module.

11. The method of claim 10 wherein the identified differences includes GPS information.

12. The method of claim 10 wherein the differences are a blockchain candidate transaction.

13. The method of claim 12 wherein the blockchain candidate transaction is compared to a blockchain navigation map.

14. The method of claim 13 wherein if the differences are valid, a validation transaction is transmitted to the blockchain map network.

15. The method of claim 14 wherein each of a plurality of motor vehicles transmits blockchain candidate transactions to the blockchain map network.

16. The method of claim 14 wherein each of a plurality of motor vehicles transmits a validation transaction to the blockchain map network if the differences identified for the respective motor vehicle are valid.

17. A method of updating a distributed navigation map for a motor vehicle, the method comprising:
evaluating and characterizing a surrounding around the motor vehicle with one or more sensors;
identifying with a discrepancy detector differences in the surrounding compared to a known navigation map based on information received from the one or more sensors; and
transmitting the differences to a blockchain map network through a telematics module, the identified differences including GPS information,
wherein the differences are a blockchain candidate transaction compared to a blockchain navigation map.

18. The method of claim 17 wherein if the differences are valid, a validation transaction is transmitted to the blockchain map network.

19. The method of claim 17 wherein each of a plurality of motor vehicles transmits blockchain candidate transactions to the blockchain map network.

20. The method of claim 17 wherein each of a plurality of motor vehicles transmits a validation transaction to the blockchain map network if the differences identified for the respective motor vehicle are valid.
